(19) United States
(12) Patent Application Publication
(10) Pub. No.: US 2026/0304398 A1
(43) Pub. Date: Oct. 1, 2026

(54) SCHEDULING FREQUENCY DOMAIN RESOURCES

(71) Applicant: Nokia Solutions and Networks Oy, Espoo (FI)

(72) Inventor: Kalle Petteri KELA, Espoo (FI)

(21) Appl. No.: 19/475,906

(22) PCT Filed: Apr. 19, 2023
(86) PCT No.: PCT/EP2023/060110

§ 371 Date: Oct. 16, 2025

(51) Int. Cl. H04W 72/0453; H04B 7/06; H04L 41/16; H04W 72/1263

(52) U.S. Cl. CPC H04W 72/0453; H04B 7/0626; H04L 41/16; H04W 72/1263

(57) ABSTRACT

Disclosed is a method comprising obtaining, for a frequency domain scheduler, a set of candidates, wherein the candidates are terminal devices, determining available frequency domain resources for the set of candidates, determining input state vectors for the available frequency domain resources, wherein an individual input state vector is per one available frequency domain resource, providing the input state vectors for a machine learning model, and performing, using the machine learning model, at least one scheduling decision, wherein an individual scheduling decision comprises selecting, per one available frequency resource, one candidate from the set of candidates, and wherein the machine learning model utilizes channel state information, per the one available frequency resource, for performing the scheduling decision.

### FIELD

The following exemplary embodiments relate to wireless communication and allocating resources for transmissions.

### BACKGROUND

Cellular communication networks allow transmissions between an access node and a plurality of terminal devices, served by the access node, by allocating resources between the plurality of terminal devices. A transmission of data takes place once there is data to be transmitted between the access node and one of the terminal devices served by the access node. To allow the transmissions to occur efficiently, optimal allocation of resources used for the transmissions between multiple terminal devices is desirable.

### BRIEF DESCRIPTION

The scope of protection sought for various embodiments of the invention is set out by the independent claims. The exemplary embodiments and features, if any, described in this specification that do not fall under the scope of the independent claims are to be interpreted as examples useful for understanding various embodiments of the invention.

According to a first aspect there is provided an apparatus comprising means for performing: obtaining, for a frequency domain scheduler, a set of candidates, wherein the candidates are terminal devices, determining available frequency domain resources for the set of candidates, determining input state vectors for the available frequency domain resources, wherein an individual input state vector is per one available frequency domain resource, providing the input state vectors for a machine learning model, and performing, using the machine learning model, at least one scheduling decision, wherein an individual scheduling decision comprises selecting, per one available frequency resource, one candidate from the set of candidates, and wherein the machine learning model utilizes channel state information, per the one available frequency resource, for performing the scheduling decision.

In some example embodiments according to the first aspect, the means comprises at least one processor, and at least one memory storing instructions that, when executed by the at least one processor, to cause the performance of the apparatus.

According to a second aspect there is provided an apparatus comprising at least one processor, and at least one memory storing instructions that, when executed by the at least one processor, to cause the apparatus at least to: obtain, for a frequency domain scheduler, a set of candidates, wherein the candidates are terminal devices, determine available frequency domain resources for the set of candidates, determine input state vectors for the available frequency domain resources, wherein an individual input state vector is per one available frequency domain resource, provide the input state vectors for a machine learning model, and perform, using the machine learning model, at least one scheduling decision, wherein an individual scheduling decision comprises selecting, per one available frequency resource, one candidate from the set of candidates, and wherein the machine learning model utilizes channel state information, per the one available frequency resource, for performing the scheduling decision.

According to a third aspect there is provided a method comprising: obtaining, for a frequency domain scheduler, a set of candidates, wherein the candidates are terminal devices, determining available frequency domain resources for the set of candidates, determining input state vectors for the available frequency domain resources, wherein an individual input state vector is per one available frequency domain resource, providing the input state vectors for a machine learning model, and performing, using the machine learning model, at least one scheduling decision, wherein an individual scheduling decision comprises selecting, per one available frequency resource, one candidate from the set of candidates, and wherein the machine learning model utilizes channel state information, per the one available frequency resource, for performing the scheduling decision.

In some example embodiment according to the third aspect the method is a computer implemented method.

According to a fourth aspect there is provided a computer program comprising instructions which, when executed by an apparatus, cause the apparatus to perform at least the following: obtain, for a frequency domain scheduler, a set of candidates, wherein the candidates are terminal devices, determine available frequency domain resources for the set of candidates, determine input state vectors for the available frequency domain resources, wherein an individual input state vector is per one available frequency domain resource, provide the input state vectors for a machine learning model, and perform, using the machine learning model, at least one scheduling decision, wherein an individual scheduling decision comprises selecting, per one available frequency resource, one candidate from the set of candidates, and wherein the machine learning model utilizes channel state information, per the one available frequency resource, for performing the scheduling decision.

According to a fifth aspect there is provided a computer program comprising instructions stored thereon for performing at least the following: obtaining, for a frequency domain scheduler, a set of candidates, wherein the candidates are terminal devices, determining available frequency domain resources for the set of candidates, determining input state vectors for the available frequency domain resources, wherein an individual input state vector is per one available frequency domain resource, providing the input state vectors for a machine learning model, and performing, using the machine learning model, at least one scheduling decision, wherein an individual scheduling decision comprises selecting, per one available frequency resource, one candidate from the set of candidates, and wherein the machine learning model utilizes channel state information, per the one available frequency resource, for performing the scheduling decision.

According to a sixth aspect there is provided a non-transitory computer readable medium comprising program instructions that, when executed by an apparatus, cause the apparatus to perform at least the following: obtain, for a frequency domain scheduler, a set of candidates, wherein the candidates are terminal devices, determine available frequency domain resources for the set of candidates, determine input state vectors for the available frequency domain resources, wherein an individual input state vector is per one available frequency domain resource, provide the input state vectors for a machine learning model, and perform, using the machine learning model, at least one scheduling decision, wherein an individual scheduling decision comprises selecting, per one available frequency resource, one candidate from the set of candidates, and wherein the machine learning model utilizes channel state information, per the one available frequency resource, for performing the scheduling decision.

According to a seventh aspect there is provided a non-transitory computer readable medium comprising program instructions stored thereon for performing at least the following: obtaining, for a frequency domain scheduler, a set of candidates, wherein the candidates are terminal devices, determining available frequency domain resources for the set of candidates, determining input state vectors for the available frequency domain resources, wherein an individual input state vector is per one available frequency domain resource, providing the input state vectors for a machine learning model, and performing, using the machine learning model, at least one scheduling decision, wherein an individual scheduling decision comprises selecting, per one available frequency resource, one candidate from the set of candidates, and wherein the machine learning model utilizes channel state information, per the one available frequency resource, for performing the scheduling decision.

According to an eighth aspect there is provided a computer readable medium comprising program instructions that, when executed by an apparatus, cause the apparatus to perform at least the following: obtain, for a frequency domain scheduler, a set of candidates, wherein the candidates are terminal devices, determine available frequency domain resources for the set of candidates, determine input state vectors for the available frequency domain resources, wherein an individual input state vector is per one available frequency domain resource, provide the input state vectors for a machine learning model, and perform, using the machine learning model, at least one scheduling decision, wherein an individual scheduling decision comprises selecting, per one available frequency resource, one candidate from the set of candidates, and wherein the machine learning model utilizes channel state information, per the one available frequency resource, for performing the scheduling decision.

According to a ninth aspect there is provided a computer readable medium comprising program instructions stored thereon for performing at least the following: obtaining, for a frequency domain scheduler, a set of candidates, wherein the candidates are terminal devices, determining available frequency domain resources for the set of candidates, determining input state vectors for the available frequency domain resources, wherein an individual input state vector is per one available frequency domain resource, providing the input state vectors for a machine learning model, and performing, using the machine learning model, at least one scheduling decision, wherein an individual scheduling decision comprises selecting, per one available frequency resource, one candidate from the set of candidates, and wherein the machine learning model utilizes channel state information, per the one available frequency resource, for performing the scheduling decision.

According to a tenth aspect there is provided an apparatus comprising means for performing: receiving, from another apparatus, information regarding a transmission, wherein the transmission is with respect to a terminal device and the transmission is performed in accordance with one or more scheduling decisions made by a frequency domain scheduler comprised in the other apparatus, and wherein an individual scheduling decision allocates an available frequency domain resource to the terminal device in accordance with an output of a machine learning model, collecting, for the transmission, evaluation information, wherein the evaluation information comprises input state vector per available frequency domain resource, scheduling action per the available frequency domain resource, and reward for the transmission, determining mapping between the reward for the transmissions and states and scheduling action per available frequency domain resource, storing to a replay memory, per one available frequency domain resource, the determined mapping, and performing an evaluation of the machine learning model based on the evaluation information.

In some example embodiments according to the tenth aspect, the means comprises at least one processor, and at least one memory storing instructions that, when executed by the at least one processor, to cause the performance of the apparatus.

According to an eleventh aspect there is provided an apparatus comprising at least one processor, and at least one memory storing instructions that, when executed by the at least one processor, to cause the apparatus at least to: receive, from another apparatus, information regarding a transmission, wherein the transmission is with respect to a terminal device and the transmission is performed in accordance with one or more scheduling decisions made by a frequency domain scheduler comprised in the other apparatus, and wherein an individual scheduling decision allocates an available frequency domain resource to the terminal device in accordance with an output of a machine learning model, collect, for the transmission, evaluation information, wherein the evaluation information comprises input state vector per available frequency domain resource, scheduling action per the available frequency domain resource, and reward for the transmission, determine mapping between the reward for the transmissions and states and scheduling action per available frequency domain resource, store to a replay memory, per one available frequency domain resource, the determined mapping, and perform an evaluation of the machine learning model based on the evaluation information.

According to a twelfth aspect there is provided a method comprising: receiving, from another apparatus, information regarding a transmission, wherein the transmission is with respect to a terminal device and the transmission is performed in accordance with one or more scheduling decisions made by a frequency domain scheduler comprised in the other apparatus, and wherein an individual scheduling decision allocates an available frequency domain resource to the terminal device in accordance with an output of a machine learning model, collecting, for the transmission, evaluation information, wherein the evaluation information comprises input state vector per available frequency domain resource, scheduling action per the available frequency domain resource, and reward for the transmission, determining mapping between the reward for the transmissions and states and scheduling action per available frequency domain resource, storing to a replay memory, per one available frequency domain resource, the determined mapping, and performing an evaluation of the machine learning model based on the evaluation information.

In some example embodiment according to the twelfth aspect the method is a computer implemented method.

According to a thirteenth aspect there is provided a computer program comprising instructions which, when executed by an apparatus, cause the apparatus to perform at least the following: receive, from another apparatus, information regarding a transmission, wherein the transmission is with respect to a terminal device and the transmission is performed in accordance with one or more scheduling decisions made by a frequency domain scheduler comprised in the other apparatus, and wherein an individual scheduling decision allocates an available frequency domain resource to the terminal device in accordance with an output of a machine learning model, collect, for the transmission, evaluation information, wherein the evaluation information comprises input state vector per available frequency domain resource, scheduling action per the available frequency domain resource, and reward for the transmission, determine mapping between the reward for the transmissions and states and scheduling action per available frequency domain resource, store to a replay memory, per one available frequency domain resource, the determined mapping, and perform an evaluation of the machine learning model based on the evaluation information.

According to a fourteenth aspect there is provided a computer program comprising instructions stored thereon for performing at least the following: receiving, from another apparatus, information regarding a transmission, wherein the transmission is with respect to a terminal device and the transmission is performed in accordance with one or more scheduling decisions made by a frequency domain scheduler comprised in the other apparatus, and wherein an individual scheduling decision allocates an available frequency domain resource to the terminal device in accordance with an output of a machine learning model, collecting, for the transmission, evaluation information, wherein the evaluation information comprises input state vector per available frequency domain resource, scheduling action per the available frequency domain resource, and reward for the transmission, determining mapping between the reward for the transmissions and states and scheduling action per available frequency domain resource, storing to a replay memory, per one available frequency domain resource, the determined mapping, and performing an evaluation of the machine learning model based on the evaluation information.

According to a fifteenth aspect there is provided a non-transitory computer readable medium comprising program instructions that, when executed by an apparatus, cause the apparatus to perform at least the following: receive, from another apparatus, information regarding a transmission, wherein the transmission is with respect to a terminal device and the transmission is performed in accordance with one or more scheduling decisions made by a frequency domain scheduler comprised in the other apparatus, and wherein an individual scheduling decision allocates an available frequency domain resource to the terminal device in accordance with an output of a machine learning model, collect, for the transmission, evaluation information, wherein the evaluation information comprises input state vector per available frequency domain resource, scheduling action per the available frequency domain resource, and reward for the transmission, determine mapping between the reward for the transmissions and states and scheduling action per available frequency domain resource, store to a replay memory, per one available frequency domain resource, the determined mapping, and perform an evaluation of the machine learning model based on the evaluation information.

According to a sixteenth aspect there is provided a non-transitory computer readable medium comprising program instructions stored thereon for performing at least the following: receiving, from another apparatus, information regarding a transmission, wherein the transmission is with respect to a terminal device and the transmission is performed in accordance with one or more scheduling decisions made by a frequency domain scheduler comprised in the other apparatus, and wherein an individual scheduling decision allocates an available frequency domain resource to the terminal device in accordance with an output of a machine learning model, collecting, for the transmission, evaluation information, wherein the evaluation information comprises input state vector per available frequency domain resource, scheduling action per the available frequency domain resource, and reward for the transmission, determining mapping between the reward for the transmissions and states and scheduling action per available frequency domain resource, storing to a replay memory, per one available frequency domain resource, the determined mapping, and performing an evaluation of the machine learning model based on the evaluation information.

According to a seventeenth aspect there is provided a computer readable medium comprising program instructions that, when executed by an apparatus, cause the apparatus to perform at least the following: receive, from another apparatus, information regarding a transmission, wherein the transmission is with respect to a terminal device and the transmission is performed in accordance with one or more scheduling decisions made by a frequency domain scheduler comprised in the other apparatus, and wherein an individual scheduling decision allocates an available frequency domain resource to the terminal device in accordance with an output of a machine learning model, collect, for the transmission, evaluation information, wherein the evaluation information comprises input state vector per available frequency domain resource, scheduling action per the available frequency domain resource, and reward for the transmission, determine mapping between the reward for the transmissions and states and scheduling action per available frequency domain resource, store to a replay memory, per one available frequency domain resource, the determined mapping, and perform an evaluation of the machine learning model based on the evaluation information.

According to an eighteenth aspect there is provided a computer readable medium comprising program instructions stored thereon for performing at least the following: receiving, from another apparatus, information regarding a transmission, wherein the transmission is with respect to a terminal device and the transmission is performed in accordance with one or more scheduling decisions made by a frequency domain scheduler comprised in the other apparatus, and wherein an individual scheduling decision allocates an available frequency domain resource to the terminal device in accordance with an output of a machine learning model, collecting, for the transmission, evaluation information, wherein the evaluation information comprises input state vector per available frequency domain resource, scheduling action per the available frequency domain resource, and reward for the transmission, determining mapping between the reward for the transmissions and states and scheduling action per available frequency domain resource, storing to a replay memory, per one available frequency domain resource, the determined mapping, and performing an evaluation of the machine learning model based on the evaluation information.

### LIST OF DRAWINGS

In the following, the invention will be described in greater detail with reference to the embodiments and the accompanying drawings, in which

FIG. 1 illustrates an exemplary embodiment of a radio access network.

FIG. 2 illustrates an example embodiment of a framework that may be used to perform scheduling of the data packets.

FIG. 3 illustrates an example embodiment in which machine learning is utilized for scheduling frequency domain resources.

FIG. 4 illustrates an example embodiment of an actor-critic approach.

FIG. 5 and FIG. 6 illustrate flow charts according to example embodiments.

FIG. 7 illustrates an example embodiment of a neural network topology.

FIG. 8 illustrates graphs of user throughput for example embodiments.

FIG. 9 illustrates graphs of gains achieved by a system level simulator.

FIG. 10 illustrates a graph regarding benefits achieved in scheduling in an example embodiment.

FIG. 11 illustrates an example embodiment of an apparatus.

### DESCRIPTION OF EMBODIMENTS

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device. The above-described embodiments of the circuitry may also be considered as embodiments that provide means for carrying out the embodiments of the methods or processes described in this document.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via any suitable means. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments described herein may be implemented in a communication system, such as in at least one of the following: Global System for Mobile Communications (GSM) or any other second generation cellular communication system, Universal Mobile Telecommunication System (UMTS, 3G) based on basic wideband-code division multiple access (W-CDMA), high-speed packet access (HSPA), Long Term Evolution (LTE), LTE-Advanced, a system based on IEEE 802.11 specifications, a system based on IEEE 802.15 specifications, a fifth generation (5G) mobile or cellular communication system, 5G-Advanced and/or 6G. The embodiments are not, however, restricted to the systems given as an example but a person skilled in the art may apply the solution to other communication systems provided with necessary properties.

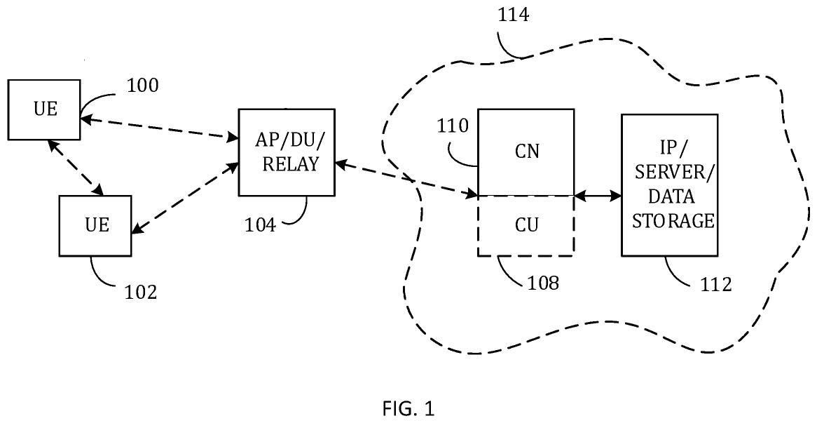

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may comprise also other functions and structures than those shown in FIG. 1. The example of FIG. 1 shows a part of an exemplifying radio access network.

FIG. 1 shows terminal devices 100 and 102 configured to be in a wireless connection on one or more communication channels in a cell with an access node (such as (e/g)NodeB) 104 providing the cell. The terminal devices 100 and 102 may also be called as mobile device, or user equipment (UE), or user terminal, user device, etc. The access node 104 may also be referred to as a node, or a base station, or any other type of interfacing device including a relay station capable of operating in a wireless environment. The physical link from a terminal device to a (e/g)NodeB is called uplink or reverse link and the physical link from the (e/g)NodeB to the terminal device is called downlink or forward link. It should be appreciated that (e/g)NodeBs or their functionalities may be implemented by using any node, host, server or access point etc. entity suitable for such a usage. It is to be noted that although one cell is discussed in this exemplary embodiment, for the sake of simplicity of explanation, multiple cells may be provided by one access node in some example embodiments.

A communication system may comprise more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 110 (CN or next generation core NGC). Depending on the system, the counterpart on the CN side may be a serving gateway (S-GW, routing and forwarding user data packets), packet data network gateway (P-GW), for providing connectivity of terminal devices to external packet data networks, or mobile management entity (MME), etc.

The terminal device illustrates one type of an apparatus to which resources on the air interface are allocated and assigned, and thus any feature described herein with a terminal device may be implemented with a corresponding apparatus, such as a relay node. An example of such a relay node is a layer 3 relay (self-backhauling relay) towards the base station. Another example of such a relay node is a layer 2 relay. Such a relay node may contain a terminal device part and a Distributed Unit (DU) part. A CU (centralized unit) may coordinate the DU operation via F1AP-interface for example.

The terminal device may refer to a portable computing device that includes wireless mobile communication devices operating with or without a subscriber identification module (SIM), or an embedded SIM, eSIM. A terminal device may also be a device having capability to operate in Internet of Things (IoT) network which is a scenario in which objects are provided with the ability to transfer data over a network without requiring human-to-human or human-to-computer interaction. The terminal device may also utilise cloud computing. The terminal device (or in some embodiments a layer 3 relay node) is configured to perform one or more of user equipment functionalities.

Additionally, although the apparatuses have been depicted as single entities, different units, processors and/or memory units (not all shown in FIG. 1) may be implemented.

5G enables using multiple input—multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications such as (massive) machine-type communications (mMTC), including vehicular safety, different sensors and real-time control. 5G is expected to have multiple radio interfaces, namely below 6 GHz, cmWave and mmWave, and also being integratable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz—cmWave, below 6 GHz—cmWave—mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The architecture in LTE networks is fully distributed in the radio and fully centralized in the core network. The low latency applications and services in 5G may require bringing the content close to the radio which may lead to local break out and multi-access edge computing (MEC). 5G enables analytics and knowledge generation to occur at the source of the data. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, and/or utilise services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 104) and non-real time functions being carried out in a centralized manner (in a centralized unit, CU 108).

It should also be understood that the distribution of labour between core network operations and base station operations may differ from that of the LTE or even be non-existent. Some other technology that may be used includes for example Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

It is to be noted that the depicted system is an example of a part of a radio access system and the system may comprise a plurality of (e/g)NodeBs, the terminal device may have an access to a plurality of radio cells and the system may comprise also other apparatuses, such as physical layer relay nodes or other network elements, etc. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. In some exemplary embodiments, in multilayer networks, one access node provides one kind of a cell or cells, and thus a plurality of (e/g)NodeBs are required to provide such a network structure.

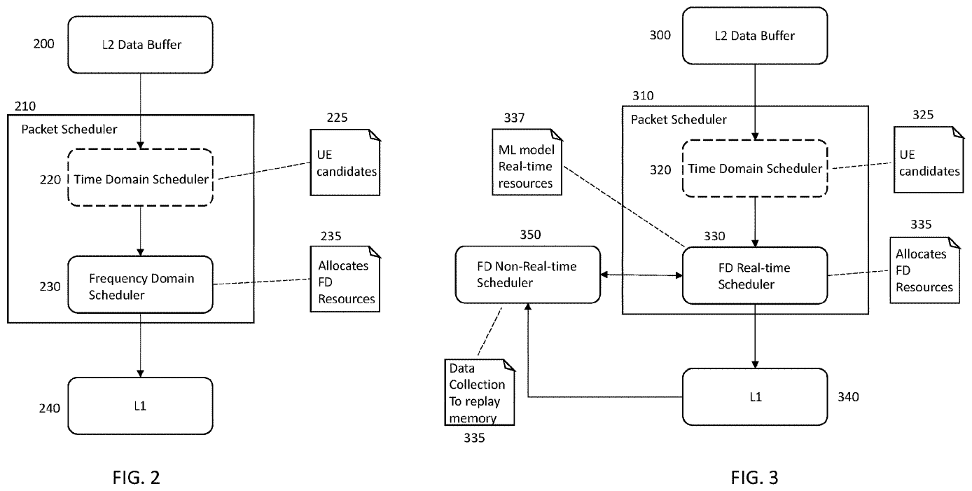

To enable transmissions between an access node and a plurality of terminal devices, resources available for transmissions in time domain (TD) and in frequency domain (FD) may be allocated between the plurality of terminal devices. In a data transmission, data packets may be transmitted between a terminal device and an access node that serves the terminal device. When the resources available for the transmission are allocated to the terminal device, the access node may perform the allocation with respect to other terminal devices it serves. Thus, the access node performs scheduling for the data packets that are to be transmitted. FIG. 2 illustrates an example embodiment of a framework that may be used, by the access node, to perform scheduling of the data packets. In this example embodiment, in downlink (DL) scheduling, the status of one or more L2 data buffers 200 are known by a packet scheduler 210 comprised in the access node. Thus, the status indicates if there is a need for data packet scheduling. Additionally, in case of uplink (UL) scheduling, the terminal devices served by the access node send scheduling requests and report their uplink buffer statuses with buffer status reports (BSR) within medium access control (MAC) control element (CE). In this example embodiment, the packet scheduler 210 comprises a TD scheduler 220 and an FD scheduler 230. The TD scheduler 220 selects n≤N candidates, that are terminal devices served by the access node, from all scheduling candidates N, for which there is data in the L2 data buffer or in an uplink buffer of a terminal device. In other words, a set of candidates are selected, and the candidates are terminal devices that can be scheduled for transmission. Once the set of candidates is selected by the TD scheduler 220, the FD scheduler 230 then allocates available FD resources 235 for the candidates for transmission. Once the available FD resources are allocated to the set of candidates, in other words, one or more scheduling decisions are made, the one or more scheduling decisions are provided to layer 1 (L1) 240 for allocating resources according to the one or more scheduling decision using control channel signalling. For one transmission, one or more scheduling decisions may be performed. It is to be noted that an available FD resource may be understood to be one of the following: a single resource block, resource block group, a predefined set of resource blocks, or a predefined set of resource block groups.

Yet, scheduling for UL transmission may be complicated due to random interference and different power capabilities of different terminal devices. Even though algorithms for scheduling have been simplified, they may still require a lot of different calculation steps per available FD resource, such as a resource block (RB) or resource block group (RBG), to be allocated. Thus, a great number of computation loops with physics-based calculations may be executed for every transmission time interval (TTI), and there may be less than 1 ms time to execute them, to achieve optimized scheduling decisions. Hence, running heuristic schedulers with real time computational resources available in system on a chip (SoC) may turn out to be challenging for example with the shortest transmission time interval (TTI) lengths in 5G. Thus, while an FD scheduler is to optimize spectral efficiency, it is also desirable to reduce complexity.

Machine learning (ML) may thus be used to obtain a computationally simplified FD scheduler, with respect to a heuristic FD scheduler, may also be utilized to learn more optimal allocations of available FD resources such as, a resource block (RB) or a resource block group (RBG). It is to be noted though that although the scheduler may be simplified in terms of computation, the scheduling logic on the other hand may be more complex with respect to heuristic FD scheduler. For example, when scheduling FD resources for UL transmissions, the terminal devices served by the access node may be heterogenous in terms of their capabilities, and machine learning may learn patterns that may be utilized in scheduling such that ML based scheduling of available FD resources may outperform algorithms made with human logic. A machine learning model may learn to take into account different aspects such as current channel conditions, packet type, packet size, past performance, for example past throughput, etc. and generate scheduling patterns that vary optimally per RB and TTI. Because scheduling is done per TTI, the processing required per TTI is desirable to be minimized in order to minimize the computational complexity of real time processing part executed every TTI.

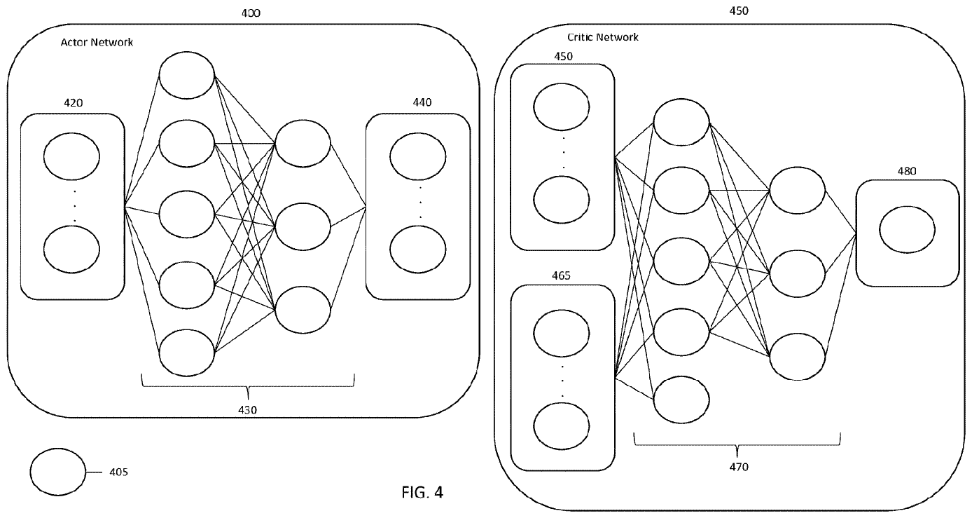

When scheduling available FD resources to a set of candidates, the FD scheduler may utilize machine learning as illustrated in FIG. 3. In this example embodiment, there is an L2 data buffer 300 in which the data to be scheduled for DL transmissions is stored. Then the packet scheduler 310, that is comprised in an access node, performs the allocation of resources to different terminal devices. In this example embodiment, the packet scheduler 310 comprises a TD scheduler 320, which may also be referred to as a pre-scheduler, that selects the set of candidates 325, which are terminal devices served by the access node. Yet, alternatively, the set of candidates may also be obtained in a different manner, in other words, without the TD scheduler 320. In addition to the TD scheduler 320, the packet scheduler 310 comprises in this example embodiment also an FD scheduler 330.

In this example embodiment, the FD scheduler 330 is a real-time scheduler that utilizes a machine learning (ML) model, which in this example embodiment is a trained ML model, to make scheduling decisions and it uses real-time computing resources 337. Therefore, it can be understood as a real-time scheduler. The functionality of the FD scheduler 330 may be performed using computing resources of an apparatus, which is comprised in the access node. Thus, the apparatus comprises computing resources, that are the real-time computing resources 337. Further, the trained ML model is, in this example embodiment, comprised in the apparatus. In this example embodiment, the set of candidates, that are selected by the TD scheduler 320 for the FD scheduler, comprises a number of candidates that is less than, or equal to, a maximum number of candidates for which the machine learning model has been trained. For example, if the ML model is based on a neural network, then due to the topology of the neural network, it may be initialized for a certain maximum number of candidates. If the number of candidates in the set of candidates is less than the maximum number of candidates for which the ML model has been trained, invalid inputs may be masked to zero and invalid outputs generate empty allocations.

The FD scheduler 330 is comprised in the access node, as the packet scheduler 310 that comprises the FD scheduler 330 is comprised in the access node. The FD scheduler 330 selects which available FD resources are to be allocated to which terminal device of the set of terminal devices. FD resources may be understood as RBs or RBGs. The ML model utilizes channel state information for each available FD resource and thus, the FD scheduler 330 forms one or more input vector for the ML model, such as a neural network. It is to be noted though that any suitable reinforcement learning algorithm may be used as the ML model. The ML model then provides, as an output, an optimal selection of a terminal device, from the set of candidates, for each available FD resource. Thus, the ML model performs a scheduling decision per an available FD resource and one transmission may require one or more such scheduling decisions. Once the available FD resources are allocated to the set of candidates, in other words, one or more scheduling decisions are made, the one or more scheduling decisions are provided to layer 1 (L1) 340 for allocating resources according to the one or more scheduling decision using control channel signalling.

As the FD scheduler 330 utilizes a ML model, the scheduling decisions obtained as outputs of the ML model are to be evaluated. This may require more resources than obtaining the outputs, which comprise the scheduling decision and which are obtained using the real-time computing resources. In order to optimize the usage of the real-time computing resources, the evaluation of the outputs of the ML model and possible re-training of the ML model may be executed in another computing entity, for example, in another apparatus that may be, or may be comprised in, a computing device, the access node, another access node or an edge computing entity. It is to be noted that this other apparatus may therefore comprise computing resources other than the real-time computing resources comprised in the apparatus that is used to perform the functionality of the FD scheduler 330. Also, this other apparatus may be comprised in the access node, which also comprises the apparatus used for performing the functionality of the FD scheduler and to store the trained ML model, or alternatively, may be comprised for example in another access node, in an edge computing unit, in a cloud computing entity, or in any other suitable device. Thus, the real-time computing resources used for by the FD scheduler 330 may be different computing resources than computing resources, which are non-real-time computing resources, used for the evaluation of the outputs of the ML model and for training of the ML model. The evaluation does not need to follow as strict time constraints as the computation of the scheduling decisions and thus, may be executed using the different, non-real-time computing resources, which, as mentioned, may be comprised in the other apparatus.

The evaluating functionality may be referred to as a non-real-time FD scheduler 350 and its functionality may thus be performed using the other apparatus. The non-real-time FD scheduler 350 collects input state vectors, actions from the FD scheduler 330 as well as additional reward information from different layers of protocol stack to its replay memory 350, which is a memory into which the data for evaluation is stored. The actions may comprise the one or more scheduling decisions. For example, for the rewarding a number of transmitted bytes per an available FD resource, and/or number of bytes correctly received, may be collected from the L1 layer. Additionally, other parameters that may be used for rewarding, for example, packet delays can be collected from MAC layer, RLC layer, PDCP layer etc. With the collected information for evaluation, that comprises the input state vectors, actions and reward information, the ML model used by the FD scheduler can be trained in the background with non-real time computational resources without explicit timing constraints. Hence, the real-time computation resources may be dedicated to perform, in this example embodiment, neural network forward propagations to obtain scheduling decisions per TTI.

For the example embodiment of FIG. 3 an Actor-Critic approach may be utilized. The example embodiment of FIG. 4 illustrates an example of such an approach. For example, a Double Deep Q Network (DDQN) and Temporal Difference Actor Critic (TD-AC) may be used. In DDQN there may be two neural networks, one for performing scheduling decisions, and one from which a soft updated target network may be for stabilizing learning at a non-real time FD scheduler. In a TD-AC implementation there may be altogether five networks, one actor network and two critic networks with their soft updated target networks. Differences between actor and critic networks are illustrated in FIG. 4, in which the actor network is illustrated as 400 and the critic network is illustrated as 450. For example, the actor network 400 may be comprised in the apparatus with real-time computing resources used for performing the functionality of the FD scheduler 330, and the critic network may be comprised in the other apparatus that comprises the non-real-time computing resources used for performing the functionality of the non-real-time FD scheduler 350. It is to be noted though that the training of the ML model may in some example embodiments take place in cloud computing. In actor-critic approach, the actor network 400 makes action decisions and critic network 450 estimates the Q-values for the actor network 400 when the model is trained. In both approaches, DDQN and TD-AC, time critical real time FD scheduler may have one neural network equivalent to actor network 400 and the non-real time FD scheduler may have a neural network corresponding to the critical network 450.

In the actor network 400 there are nodes 405 for an input layer 420 that comprises the input state vector, nodes 405 for the hidden layers 430, and nodes 405 for an output layer 440 that comprises value or probability for each action. The critic network 450 may comprise nodes for input layers 450 and 465. The input layer 450 comprises the input state vector and the input layer 465 comprises the actions. There are also nodes 405 for the hidden layers 470 and nodes 405 for the output layer 480 that comprises the estimated Q-value that can be obtained by taking a given action A from a given state S.

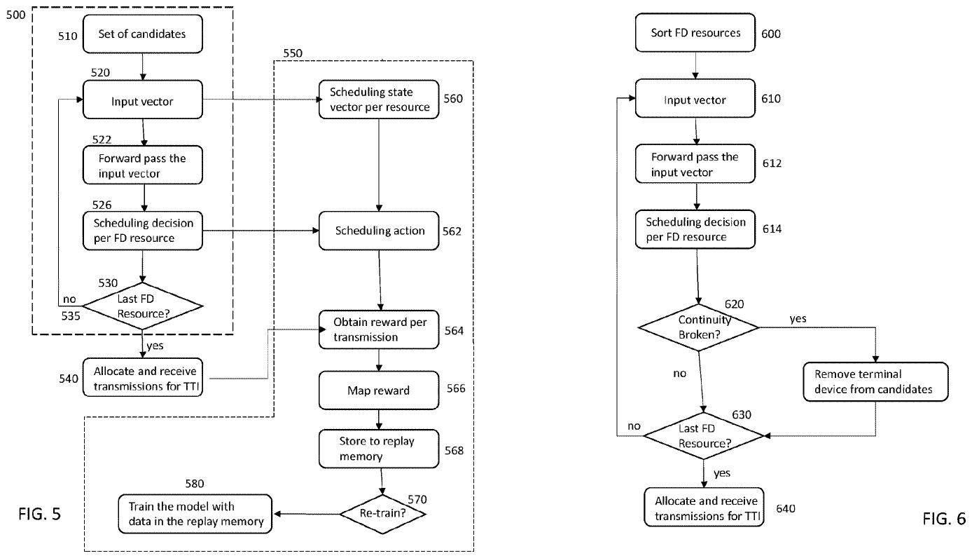

FIG. 5 illustrates a flow chart according to an example embodiment that illustrates how the real-time 500 and non-real time 550 parts of an FD scheduler may function. First, in block 520, the real-time FD scheduler 500 obtains set of candidates. The candidates are terminal devices and may also be referred to as scheduling candidates. The set of candidates may be obtained in any suitable manner, for example, from a TD scheduler. Optionally, before starting scheduling, the candidates may be shuffled randomly to avoid an ML model, such as a neural network, used to become stuck on same outputs. Also, optionally, indexes of available FD resources, such as RBs, may be shuffled randomly before looping them through the neural network for allocating them to a suitable candidate, to avoid using just the first available FD resources of the available frequency band.

Then, in block 520, input state vectors are determined for the available FD resources. In this example embodiment, there is an input state vector for each available FD resource. An available FD resource may be for example an RB or an RBG. The input state vector may comprise various values. For example, for improving overall UL performance, the input state vector may comprise, for each scheduling candidate, normalized values (ranging from 0 to 1) of one or more of the following: RB specific subband channel state information (CSI) in dB format, wideband CSI in dB format, number of so far allocated RBs per maximum number of RBs, past experienced filtered terminal device throughput, such as window averaged terminal device throughput, or packet size of the terminal device, which may be based on previous transmissions. The input state vector is the forward passed through neural network as illustrated in block 522. From the neural network output a scheduling decision is then obtained as illustrated in block 526. The scheduling decision comprises a scheduled terminal device for the corresponding available FD resource for which the input state vector was determined. Then, in block 530 it is determined if there are still more available FD resources for which a scheduling decision is to be obtained using the ML model that in this example embodiment is a neural network. If yes, then the flow chart returns to the block 520. If not, then the flow chart proceeds to block 540, in which the scheduling decisions are provided to an L1 to be allocated through control channel signalling.

By exploiting the ML model per available FD resource, it is possible that sub-band measurements are taken into account for each terminal device and input and output vector sizes, as well as the overall model size, are kept small. Hence, forward pass per available FD resource becomes more efficient than passing a bigger model forward once per TTI.

The non-real-time FD scheduler 550 then, in block 560 obtains from the real-time scheduler 500, the input state vectors. Then, in block 562, the non-real-time FD scheduler 550 obtains the scheduling decision that is an output of the ML model, executed by the real-time FD scheduler 500, and the output may be referred to as a scheduling action. Then, in block 564, once data transmissions have been received, for each terminal device reward information is obtained. The reward information in this example embodiment is a number of bytes correctly received. The reward information is then obtained by the non-real-time FD scheduler 550 and mapped to per available FD resource scheduling decision states and actions. Proportional fair may be used as a basis for a scheduling metric and thus, in order to maximize proportional fairness between terminal devices reward rᵢ of ith terminal device may be:

$${r}_{i} = \frac{b / {n}_{RBs}}{{t}_{f}} ,$$

where b is number successfully received bytes, n_{RBs} is number of RBs allocated for ith terminal device, and t_{f} is filtered past average throughput before the reception. Obtained rᵢ may then be mapped as a reward for all RBs allocated for ith terminal device. It is to be noted though that, optionally, by removing the divisor t_{f} the method may be changed to maximize cell throughput without proportional fairness.

Then, in block 568, evaluation information that comprises the previous state, action, reward and current state (SARS) tuples for each available FD resource are stored to the replay memory. In block 570 it is then determined if it is time to re-train the ML model used by the real-time FD scheduler 500. If it is, then the non-real-time FD scheduler 550 may re-train the ML model from the replay memory with configured batch sizes, number of epocs and training interval. Once the actor model is updated it may be provided to the real-time FD scheduler 500. If actor-critic method is used, it can be enough to have just the actor network part at the real-time FD scheduler 500. It is to be noted that the re-trained model, optionally the actor part of the re-trained model, may be provided to a plurality of real-time FD schedulers that may reside in different access nodes and thus benefits may be obtained by having centralized training for multiple access nodes. Alternatively, the training may be specific to one the real-time FD scheduler 500 and thereby to one access node.

By inputting general measurement results to the ML model and not tying inputs nor outputs to any certain terminal device allows the model design to become generalized so that it allows for example model federated learning aggregation between access nodes such as gNBs or 6G base stations, as long as neural network topologies match between the access nodes. Hence, to speed up training, and to decrease training efforts per an access node, access nodes may be able to share and aggregate models with each other.

Even though neural network calculations may, in some example embodiments, add some computational complexity to the scheduling of the available FD resources, the most computationally complex calculations, such as backward propagations in model training, can be made with separate computational resources without real time constraints as described in the example embodiments above. For example, a neural network based approach, such as described above, provides scheduling decision per available FD resource with one network forward pass, in an actor network, while for example heuristic methods may require for each available FD allocation process channel measurements, re-select new modulation and coding scheme (MCS), estimate power limitations of a terminal device, derive new throughput estimation etc. Hence, the example embodiments described above may simplify, at least computationally, and speed up also uplink scheduling.

In the example embodiments described above, proportional fairness-based rewarding was used. Yet, also other reward functions for different type of quality of service (QoS) flows may be utilized. For example, packet delays can be minimized for low latency QoS flows with delay-based rewards. It is also to be noted that although the example embodiments above are applicable to scheduling available FD resource for both DL and UL transmissions. For example, separate ML models for UL and DL transmissions may be trained for scheduling the available FD resources.

The example embodiments discussed above are suitable for orthogonal frequency-division multiple access (OFDMA), which is the default waveform for 5G shared data channels. In OFDMA there is freedom in frequency domain scheduling, because available FD resource allocation for a single terminal device does not have to be continuous. This may improve spectral efficiency, because it allows more freedom for frequency selective scheduling. However, for example for the uplink, some single carrier waveforms may be utilized and for the single carrier waveforms the available FD resources are to be continuous. The single carrier waveforms have some desired properties, such as lower peak-to-average-power-ratio (PAPR), which helps uplink where transmitter power efficiency is of importance. Also, single carrier waveforms may be considered for downlink for energy saving purposes. Such single carrier waveforms are for example single carrier frequency-division multiple access (SC-FDMA) and discrete Fourier transform spread orthogonal frequency-division multiplexing (DFT-s-OFDM).

To address the requirement of continuous allocations, the example embodiment of FIG. 5 may be modified as is illustrated in an example embodiment illustrated in FIG. 6. In this example embodiment, first in block 600, the available FD resources, such as RBs or RBGs, are sorted. This may be understood as arranging them in a numerical order. The order may be ascending or descending. This way the resources may be looped through the neural network in a numerical order, which may help to schedule continuous frequency allocations.

Then, in block 610 the input state vectors are determined for each available FD resource. In the state vector additional information regarding which action was taken for a previous available FD resource can be given. This may help in learning to give continuous allocations more efficiently. Then, in block 612 the input state vector is forward passed through the neural network and in block 614 a scheduling decision is obtained for the available FD resource. Next, in block 620, it is determined if the obtained scheduling decision is a decision of no allocation or allocating a terminal device other than the one allocated for the previous available FD resource. If yes, then in block 624, the terminal device allocated for the previous available FD resource is removed the set of candidates and its inputs are put to zeros for the next available FD resource. This way the there are no more available FD resources allocated the terminal device for which continuity was broken and input state vector for the next available FD resource still has the same order, i.e. inputs corresponding to still valid terminal devices are at the same places in the input state vector.

Then, in block 630 it is determined if the available FD resource was the last one for which to obtain a scheduling decision. If it is not, then the flow chart returns to the block 610. If it was, then the flow chart proceeds to block 640 and allocates resources according to the scheduling decisions and receives transmissions accordingly.

With the modifications indicated in the example embodiment of FIG. 6 it is possible to learn to provide spectral efficient continuous allocations without changes to computational efficiency.

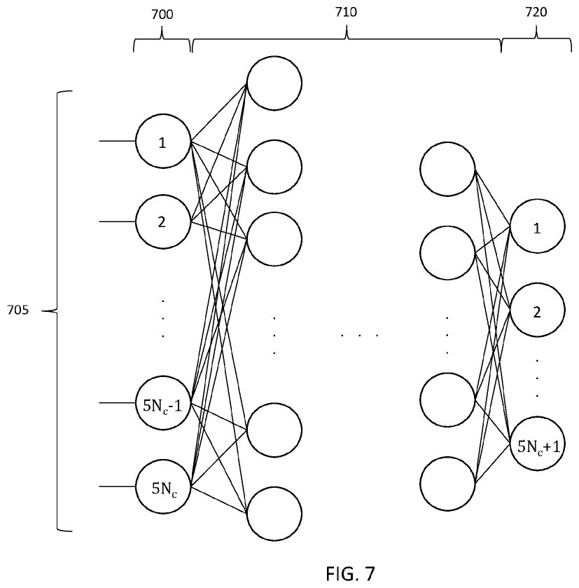

The example embodiments discussed above may also be benchmarked. In one benchmark example, a neural network topology illustrated in FIG. 7 can be utilized. In this example embodiment, there are N_{c} scheduling candidates. For evaluation, in this example embodiment, 5 input values 705 per scheduling candidate are used. Those input values are provided to the input layer 700, from which they are then provided to the hidden layers 710, from which the output at the output layer 720 is obtained. Output in this example embodiment has one neuron per action i.e. scheduling candidate plus one additional neuron for empty RB allocation. In order to obtain different outcome, inputs can be increased or decreased. Other neural network topologies and variations may be used as well. Topology is scaled with the number of supported scheduling candidates N_{c} at frequency domain.

For the benchmarking, in this example embodiment, a double deep Q network (DDQN) is used due to its good trade-off between computational complexity and performance and temporal difference actor-critic (TD-AC). Models in this example embodiment are trained during the first 100 000 simulation steps. After that, rest of the simulations were running with the real time FD scheduler. These algorithms are just an examples and other deep learning algorithms are applicable as well. In the case of actor-critic algorithm, real time FD scheduler part utilizes the actor network, while the training with critic network is performed in the non-real time part of the FD scheduler. Main parameterizations of the utilized ML models are described in Table 1.

TABLE 1

| Parameter | value |
|---|---|
| Algorithms | Double Deep Q Network (DDQN) |
| | Temporal Difference Actor- |
| | Critic (TD-AC) |
| Learning rate | 0.001 |
| Discount | 0.95 |
| Replay memory size | 10 000 |
| Epochs per training occasion | 1 |
| Target network soft update rate | 0.001 |
| Batch size | 25 |
| Training interval | 1 during the simulation warm-up. |
| | Training stopped for the rest of |
| | the simulation. |

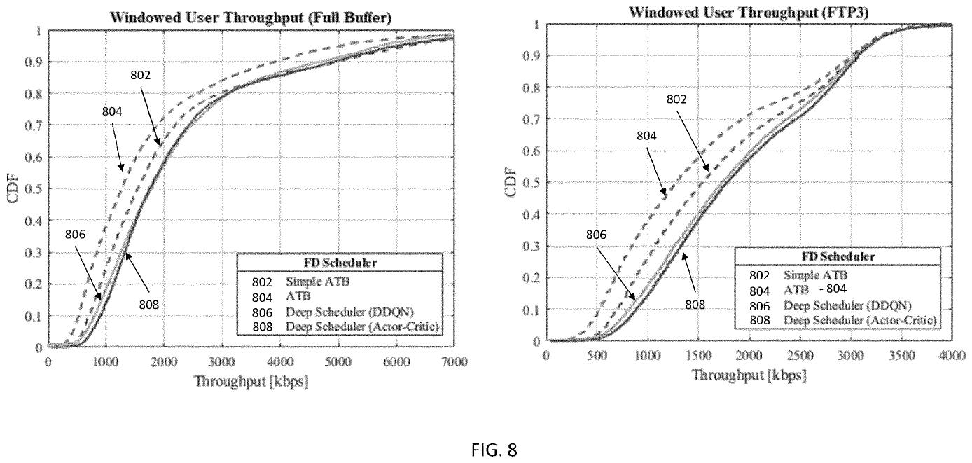

User throughput distributions for full buffer and FTP3 traffic models are shown in FIG. 8. It can be seen that FD scheduler according to the example embodiments clearly outperforms comparison schedulers, that are based on adaptive transmission bandwidth (ATB) approach, in a system level simulator for full buffer as well as for other traffic types such as FTP3 with inconstant packet arrivals. In this example embodiment, 125 packet per second on average with 1500 B packet size was used. The graph 810 illustrates results for a full buffer and the graphs 815 illustrates results for FTP3. For comparison, there are results for a simple ATB 802, an ATB 804, for a deep scheduler when using DDQN 806 and for a deep scheduler when using actor-critic approach 808.

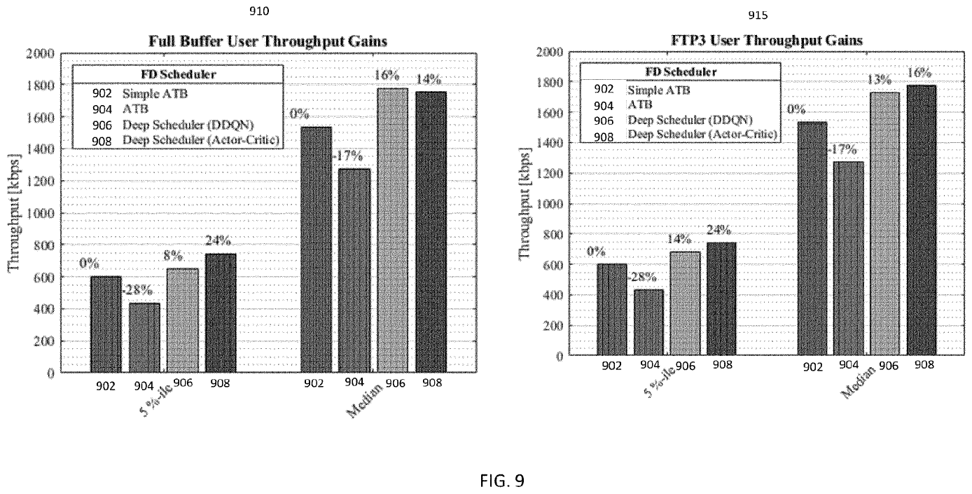

Gains compared to best performing state of the art uplink schedulers in utilized system level simulator are shown in FIG. 9. Clear performance boosts can be achieved for the “cell edge” terminal devices as well as for median terminal devices while maintaining the performance for the terminal devices with the best channel conditions. The graphs 910 illustrates gains for a full buffer and the graphs 915 illustrates results for FTP3. For comparison, there are results for a simple ATB 902, an ATB 904, for a deep scheduler when using DDQN 906 and for a deep scheduler when using actor-critic approach 908.

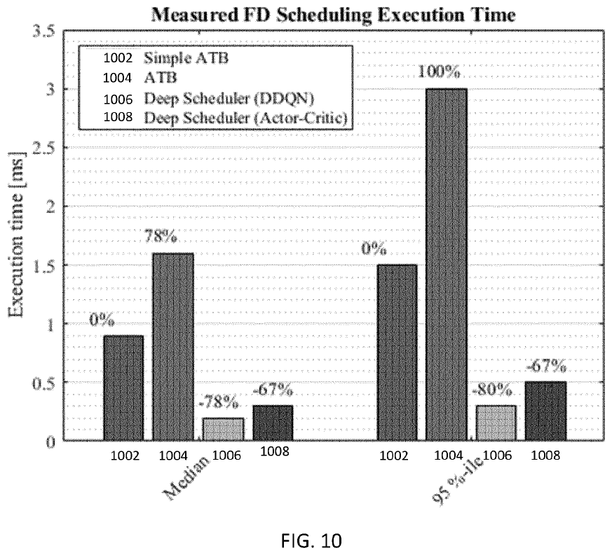

One of the benefits of the example embodiments described above is simplifying and speeding up real time per TTI dynamic scheduling. In order to benchmark execution times of the simulator's frequency domain scheduling the ML model may be trained only during the warm-up. After the warm-up training may be shut down and real time scheduler forward passes without further training to obtain scheduling decisions for each available FD resource. Hence, instead of computing all the estimates, scheduling metrics etc. for all scheduling candidates and available FD resources, the real time part of the FD scheduling becomes essentially a few matrix operations per an available FD resource, which may be implemented with C++ Eigen library for example. Same CPU or GPU resources may be used for measuring scheduling execution time from numerous simulation realizations. The benefits in terms of execution time per scheduled TTI when scheduling is performed according to the example embodiments, utilizing machine learning, described above is shown in FIG. 10. For comparison, there are results for a simple ATB 1002, an ATB 1004, for a deep scheduler when using DDQN 1006 and for a deep scheduler when using actor-critic approach 1008.

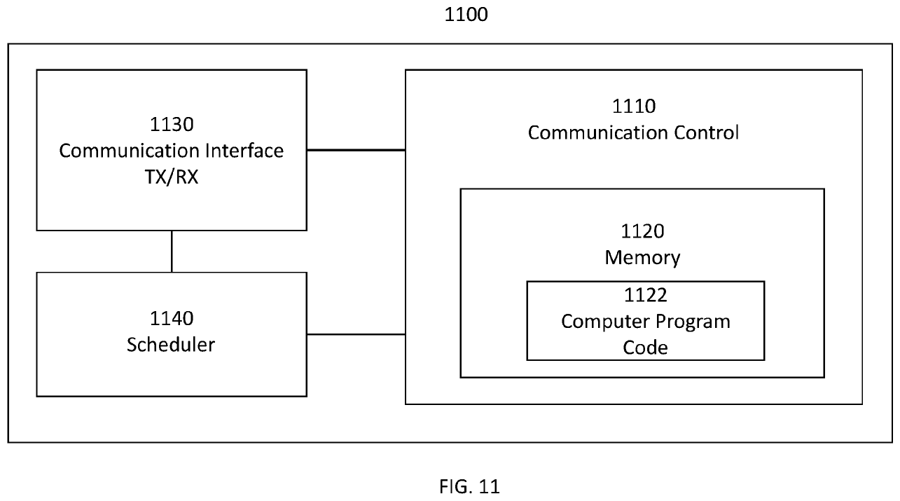

The apparatus 1100 of FIG. 11 illustrates an example embodiment of an apparatus that may be an access node or be comprised in an access node. The apparatus may be, for example, a circuitry or a chipset applicable to an access node to realize the described embodiments. The apparatus 1100 may be an electronic device comprising one or more electronic circuitries. The apparatus 1100 may comprise a communication control circuitry 1110 such as at least one processor, and at least one memory 1120 including a computer program code (software) 1122 wherein the at least one memory and the computer program code (software) 1122 are configured, with the at least one processor, to cause the apparatus 1100 to carry out any one of the example embodiments of the access node described above.

The memory 1120 may be implemented using any suitable data storage technology, such as semiconductor-based memory devices, flash memory, magnetic memory devices and systems, optical memory devices and systems, fixed memory and removable memory. The memory may comprise a configuration database for storing configuration data. For example, the configuration database may store current neighbour cell list, and, in some example embodiments, structures of the frames used in the detected neighbour cells.

The apparatus 1100 may further comprise a communication interface 1130 comprising hardware and/or software for realizing communication connectivity according to one or more communication protocols. The communication interface 1130 may provide the apparatus with radio communication capabilities to communicate in the cellular communication system. The communication interface may, for example, provide a radio interface to terminal devices. The apparatus 1100 may further comprise another interface towards a core network such as the network coordinator apparatus and/or to the access nodes of the cellular communication system. The apparatus 1100 may further comprise a scheduler 1140 that is configured to allocate resources.

Even though the invention has been described above with reference to examples according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. An apparatus comprising at least one processor, and at least one memory storing instructions that, when executed by the at least one processor, to cause the apparatus at least to:
obtain, for a frequency domain scheduler, a set of candidates, wherein the candidates are terminal devices;
determine available frequency domain resources for the set of candidates;
determine input state vectors for the available frequency domain resources, wherein an individual input state vector is per one available frequency domain resource;
provide the input state vectors for a machine learning model; and
perform, using the machine learning model, at least one scheduling decision, wherein an individual scheduling decision comprises selecting, per one available frequency resource, one candidate from the set of candidates, and wherein the machine learning model utilizes channel state information, per the one available frequency resource, for performing the scheduling decision.

2. An apparatus according to claim 1, wherein the at least one scheduling decision is performed for a transmission time interval.

3. An apparatus according to claim 1, wherein the apparatus is further caused to provide the at least one scheduling decision to a layer 1 for allocating resources according to the scheduling decision using control channel signaling.

4. (canceled)

5. An apparatus according to claim 1, wherein the individual input state vector comprises information regarding one or more of the following: sub-band channel state information, wideband channel state information, resource blocks allocated with respect to maximum number of resource blocks, window averaged terminal device throughput, or packet size of the respective terminal device.

6. An apparatus according to claim 1, wherein the apparatus is further caused to randomly shuffle an order of the candidate before performing the at least one scheduling decision.

7. An apparatus according to claim 1, wherein the apparatus is further caused to randomly shuffle indexes of the available frequency domain resources before performing the at least one scheduling decision.

8. An apparatus according to claim 1, wherein the apparatus is further caused to arrange the available frequency domain resources in a numerical order starting from the first or the last available frequency domain resource before performing the scheduling decision.

9. An apparatus according to claim 8, wherein the individual input state vector further comprises information regarding an action taken for a previous available frequency domain resource.

10. An apparatus according to claim 9, wherein the apparatus is further caused to determine that no terminal device is selected for the one available frequency domain resource, or that a terminal device different than allocated for the previous available frequency domain resource is selected, and as a response to the determination, remove the terminal device allocated for the previous available frequency domain resource from the set of candidates and set inputs of the removed terminal device to zero.

11. (canceled)

12. An apparatus according to claim 1, wherein the number of candidates in the set of candidates is less than or equal to a maximum number of candidates for which the machine learning model has been trained.

13. (canceled)

14. An apparatus according to claim 1, wherein the available frequency domain resource comprises one of the following: a single resource block, resource block group, a predefined set of resource blocks, or a predefined set of resource block groups.

15. (canceled)

16. An apparatus comprising at least one processor, and at least one memory storing instructions that, when executed by the at least one processor, to cause the apparatus at least to:
receive, from another apparatus, information regarding a transmission, wherein the transmission is with respect to a terminal device and the transmission is performed in accordance with one or more scheduling decisions made by a frequency domain scheduler comprised in the other apparatus, and wherein an individual scheduling decision allocates an available frequency domain resource to the terminal device in accordance with an output of a machine learning model,
collect, for the transmission, evaluation information, wherein the evaluation information comprises input state vector per available frequency domain resource, scheduling action per the available frequency domain resource, and reward for the transmission;
determine mapping between the reward for the transmissions and states and scheduling action per available frequency domain resource;
store to a replay memory, per one available frequency domain resource, the determined mapping; and
perform an evaluation of the machine learning model based on the evaluation information.

17. An apparatus according to claim 16, wherein based on the input state vector indicates, per available frequency domain resource, its respective previous state and current state.

18. An apparatus according to claim 16, wherein reward is one or more of the following: number of bytes correctly received, number of bytes transmitted per available frequency domain resource, or packet delays.

19. (canceled)

20. An apparatus according to claim 16, wherein the apparatus is further caused to retrain the machine learning model using the evaluation information stored on the replay memory with configured batch sizes, number of epocs and training intervals.

21. (canceled)

22. An apparatus according to claim 16, wherein the available frequency domain resource comprises one of the following: a single resource block, resource block group, a predefined set of resource blocks, or a predefined set of resource block groups.

23. A method comprising:
obtaining, for a frequency domain scheduler, a set of candidates, wherein the candidates are terminal devices;
determining available frequency domain resources for the set of candidates;
determining input state vectors for the available frequency domain resources, wherein an individual input state vector is per one available frequency domain resource;
providing the input state vectors for a machine learning model; and
performing, using the machine learning model, at least one scheduling decision, wherein an individual scheduling decision comprises selecting, per one available frequency resource, one candidate from the set of candidates, and wherein the machine learning model utilizes channel state information, per the one available frequency resource, for performing the scheduling decision.

24-26. (canceled)
